(19) United States
(12) Patent Application Publication
(10) Pub. No.: US 2024/0321511 A1
(43) Pub. Date: Sep. 26, 2024

(54) MAGNETIC ASSEMBLY, POWER CONVERSION CIRCUIT AND POWER CONVERSION DEVICE

(71) Applicant: SHANGHAI METAPWR ELECTRONICS CO., LTD, Shanghai (CN)

(72) Inventor: Jianhong ZENG, Shanghai (CN)

(73) Assignee: SHANGHAI METAPWR ELECTRONICS CO., LTD, Shanghai (CN)

(21) Appl. No.: 18/607,519

(22) Filed: Mar. 17, 2024

(30) Foreign Application Priority Data
Mar. 23, 2023 (CN) 202310292741.0

(51) Int. Cl. H01F 27/34; H01F 27/26; H01F 27/28; H02M 3/155

(52) U.S. Cl. CPC H01F 27/34; H01F 27/26; H01F 27/28; H02M 3/155

(57) ABSTRACT

A magnetic assembly is provided. The magnetic assembly comprises a magnetic core and two winding combinations. The magnetic core comprises a middle column, two side columns and two magnetic substrates. The middle column and the two side columns are arranged between the two magnetic substrates, and the middle column is arranged between the two side columns. The two winding combinations are respectively wound on one side column, each winding combination comprises two windings which are connected with each other. The voltage at the two ends of one winding wound on one side column is 90 degrees out of phase with the voltage of the two ends of one winding wound on the other side column.

### CROSS-REFERENCE TO RELATED APPLICATION

This application claims the priority benefit of China application serial no. 202310292741.0 filed on Mar. 23, 2023. The entirety of the above-mentioned patent application is hereby incorporated by reference herein and made a part of this specification.

### BACKGROUND

### Technical Field

The invention relates to a field of a high-frequency power supply, in particular to a magnetic assembly, a power conversion circuit, and a power conversion device.

### Description of Related Art

Along with the development of artificial intelligence, the power requirements of an artificial intelligence data processing chip, such as a CPU, a GPU, TPU (collectively referred to as XPU) are higher and higher, so that the power of the server is greatly increased, the power supply voltage of the server system board rises from 12V to 48V, and the two-stage voltage reduction circuit architecture gradually becomes mainstream when the power supply voltage of the server system board is 48V.

Therefore, in practical application, the decoupling capacitor C1 is added, so that different solutions of the energy storage loop L2 are reduced, the L2 loop is as small as possible, the L2 value is reduced, and rapid current rising and falling of the energy decoupling capacitor C1 are achieved.

The intermediate bus conversion device in the two-stage voltage reduction circuit architecture is a conversion device for realizing voltage conversion between an input bus and an output bus, and the ratio of the input voltage to the output voltage is of a fixed gain ratio or an unfixed gain ratio. According to the intermediate bus conversion device with the unfixed gain ratio, the input voltage in the range of 40-60 V of the server mainboard is stabilized at the 12V output voltage for supplying the memory bank load on the server mainboard, and the voltage regulator load, the fan load and the like for supplying power to the artificial intelligence chip are provided. As the power consumption on the server mainboard becomes larger and larger, the power required by the 12V voltage-stabilized output intermediate bus conversion device becomes larger and higher, and the power density and the heat dissipation requirement are higher and higher.

The application provides a series of means, which comprises the following steps: 1) reducing the capacitance of an input capacitor through two or more circuit units connected in parallel with staggered phase control strategy; 2) reducing the volume of the magnetic assembly through a magnetic integration technology; 3) reducing parasitic parameters through the layout of the device, and improving the switching frequency of the power supply module 4) reducing the parasitic resistance of the winding by arranging the surface-mounted winding on the surface of the winding substrate.

### SUMMARY

In view of the above, one of the purposes of the application is to provide a power conversion circuit also a power conversion device. The capacitance value of an input capacitor is reduced by means of two or more circuit units connected in parallel with a staggered phase control strategy. At the same time, the volume of the magnetic assembly is reduced by means of a magnetic integration technology. Parasitic parameters are reduced by means of the layout of the device, and the switching frequency of the power supply module is improved. On the other hand, the application further provides a pre-charging circuit and a clamping circuit suitable for the power conversion circuit, and various performances of the power conversion device are further optimized.

In general, one aspect provides a magnetic assembly, comprising a magnetic core and two winding combinations;
wherein the magnetic core comprises a middle column, two side columns and two magnetic substrates, wherein the middle column and the two side columns are arranged between the two magnetic substrates, and the middle column is arranged between the two side columns;
wherein the two winding combinations are respectively wound on one side column, each winding combination comprises two windings which are connected with each other, the voltage at the two ends of one winding wound on one side column is 90 degrees out of phase with the voltage of the two ends of one winding wound on the other side column.

Preferably, wherein a channel between the middle column and any side column is defined as a winding channel, each winding combination comprises two windings, one winding in the same winding combination passes through one winding channel in the first direction, and the other winding in the same winding combination passes through the same winding channel in the second direction.

Preferably, the phase shift between the alternating-current magnetic flux flowing through the two side columns along with time is 90 degrees, and the alternating-current magnetic flux flowing through the two side columns is superposed or subtracted on the middle column of the phase.

In general, one aspect provides a magnetic assembly, comprising a magnetic core and at least two winding combinations;
wherein the magnetic core comprises a middle column, two side columns and two magnetic substrates, wherein the middle column and the two side columns are arranged between the two magnetic substrates, and the middle column is arranged between the two side columns;
wherein at least two winding combinations are respectively wound on one side column, each winding combination comprises two windings which are electrically connected, each winding comprises a first end and a second end, and the first end and the second end of each winding are located on the two opposite sides of the magnetic core respectively.

Preferably, a channel between the middle column and any side column is defined as a winding channel, each winding combination comprises two windings, one winding in the same winding combination passes through one winding channel in the first direction, and the other winding in the same winding combination passes through the same winding channel in the second direction.

Preferably, the phase shift between the alternating-current magnetic flux flowing through the two side columns along with time is 90 degrees, and the alternating-current magnetic flux flowing through the two side columns is superposed or subtracted on the middle column of the phase.

In general, one aspect provides a magnetic assembly, comprising a magnetic core, a winding substrate, a first surface-mounted winding, a second surface-mounted winding and an internal winding;
wherein the magnetic core comprises at least one side column;
wherein the winding substrate comprises at least one magnetic core hole groove, at least two through holes, a first surface and a second surface which are opposite to each other, and at least one magnetic core hole groove penetrates through the first surface and the second surface for at least one side column to penetrate through;
wherein the first surface-mounted winding is arranged on the first surface, the second surface-mounted winding is arranged on the second surface, the internal winding is arranged in the winding substrate, and the first surface-mounted winding, the second surface-mounted winding and the internal winding are electrically connected through the via hole.

Preferably, the first surface-mounted winding is wound around the magnetic core hole groove for one round, and the second surface-mounted winding is wound around the magnetic core hole groove for one round.

Preferably, the inner winding is wound twice around the magnetic core hole groove.

Preferably, wherein the internal winding comprises a first internal winding and a second internal winding, the first internal winding and the second internal winding are located on the same wiring layer, and connecting points of the first internal winding and the second internal winding and the via hole are arranged on two opposite sides of the magnetic core.

In general, one aspect provides a power conversion circuit, comprising: an input positive terminal, an input negative terminal, an output positive terminal and two switch bridge arms;
wherein each switch bridge arm comprises an upper switch, a middle switch and a lower switch, wherein the upper switch, the middle switch and the lower switch are sequentially and electrically connected in series, the connection points of the upper switch and the middle switch are upper nodes, and the connection points of the middle switch and the lower switch are lower nodes;
wherein an upper switch of each switch bridge arm is electrically connected to an input positive terminal, and a lower switch of each switch bridge arm is electrically connected to an input negative terminal;
wherein the power conversion circuit also comprises a switching frequency, the switching frequency varies linearly with the input voltage over an input voltage range, and the switching frequency is constant over another input voltage range.

Preferably, when the input voltage is smaller than a preset value, the switching frequency is reduced along with the reduction of the input voltage.

Preferably, further comprising two flying capacitors, a transformer and an inductor, wherein each flying capacitor is respectively bridged between the upper node of one switch bridge arm and the lower node of the other switch bridge arm;
wherein the transformer comprises two transformer windings, the inductor comprises an inductor winding, the second ends of the two transformer windings are electrically connected and are electrically connected to the first end of the inductor winding, the first ends of the two transformer windings are electrically connected with two lower nodes respectively, and the second end of the inductor winding is electrically connected to the output negative terminal;
when the duty ratio D of the upper switch is smaller than or equal to 50%, the middle switch of one switch bridge arm and the upper switch of the other switch bridge arm are switched on and off at the same time;
when the duty ratio D of the upper switch is greater than 50%, the middle switch of one switch bridge arm and the lower switch of the other switch bridge arm are switched on and off at the same switch.

Preferably, when the input voltage is greater than a preset value, the switching frequency rises along with the increase of the input voltage.

Preferably, further comprises a transformer and a resonant capacitor; the transformer comprises a high-voltage winding and two low-voltage windings; the high-voltage winding and the resonant capacitor are connected in series between the two upper nodes; the second ends of the two low-voltage windings are electrically connected to the output positive terminal, and the first ends of the two low-voltage windings are electrically connected with the two lower nodes respectively.

In general, one aspect provides a power conversion circuit, comprising an input terminal, an output terminal, two circuit units and a clamping circuit;
wherein the two circuit units are electrically connected in parallel to the input terminal and the output terminal; each circuit unit comprises at least one switch and at least one capacitor;
wherein the clamping circuit comprises an absorption circuit and a discharge circuit, wherein the absorption circuit is bridged at two ends of at least one switch; one end of the discharge circuit is electrically connected with the absorption circuit, and the other end of the discharge circuit is electrically connected with the at least one capacitor in the other circuit unit.

Preferably, the absorption circuit comprises an absorption diode and an absorption capacitor, the discharge circuit comprises a discharge diode, one end of the discharge diode is electrically connected with the absorption capacitor and the absorption diode, and the other end of the discharge diode is electrically connected with at least one capacitor in the other circuit unit.

Preferably, each circuit unit comprises an upper switch, a middle switch, a lower switch and two switch capacitors, the upper switch, the middle switch and the lower switch are sequentially and electrically connected in series, the connection points of the upper switch and the middle switch are upper nodes, and the connection points of the middle switch and the lower switch are lower nodes; the input terminal comprises an input positive terminal and an input negative terminal, the upper switch of each switch bridge arm is electrically connected to the input positive terminal, and the lower switch of each switch bridge arm is electrically connected to the input negative terminal; and the two ends of each flying capacitor are separately connected the upper node of one switch bridge arm and the lower node of the other switch bridge arm.

Preferably, the absorption circuit is connected with the two ends of the upper switch in parallel, one end of the absorption capacitor is electrically connected with the input positive terminal, the other end of the absorption capacitor is electrically connected with the positive electrode of the absorption diode and the negative electrode of the discharge diode, the negative electrode of the absorption diode is electrically connected with one upper node, and the positive electrode of the discharge diode is electrically connected with any upper node of the other circuit unit.

Preferably, the absorption circuit is connected with the two ends of the lower switch in parallel, one end of the absorption capacitor is electrically connected with the input negative terminal, the other end of the absorption capacitor is electrically connected with the negative electrode of the absorption diode and the positive electrode of the discharge diode, the positive electrode of the absorption diode is electrically connected with the lower node, and the negative electrode of the discharge diode is electrically connected with the other upper node of the other circuit unit.

In general, one aspect provides a power conversion device, comprising a winding substrate, a transformer, an inductor and at least one switch;
wherein the winding substrate comprises a first surface and a second surface which are opposite to each other;
wherein the first surface comprises a power circuit region, a transformer region and an inductor region;
wherein the power circuit region, the transformer region and the inductor region are sequentially arranged in the same direction;
wherein the at least one switch is arranged in the power circuit region, the transformer is arranged in the transformer region, and the inductor is arranged in the inductor region.

Preferably, the first surface further comprises an output pin region, and the inductor region is arranged between the output pin region and the transformer region.

Preferably, the at least one switch is a lower switch, and the lower switch is arranged in the power circuit region and adjacent to the transformer region.

Preferably, the transformer comprises a transformer magnetic core, the transformer magnetic core comprises two winding channels, a first winding channel side and a second winding channel side, and the two winding channels penetrate through the first winding channel side and the second winding channel side; and the lower switch is close to the first winding channel side, and the inductor region is close to the second winding channel side.

Preferably, the inductor comprises an inductor magnetic core, the inductor magnetic core comprises two winding channels, a first winding channel side and a second winding channel side, and the two winding channels penetrate through the first winding channel side and the second winding channel side; and the transformer region is close to the first winding channel side, and the output pin region is close to the second winding channel side.

In general, one aspect provides a power conversion device, comprising a winding substrate and two switch bridge arms. The winding substrate comprises a first surface and a second surface which are opposite to each other. The first surface comprises an upper switch region and a lower switch region.
wherein each switch bridge arm comprises an upper switch, a middle switch and a lower switch, an upper switch and a middle switch in the same switch bridge arm are electrically connected to an upper node, and the middle switch and the lower switch are electrically connected to a lower node.
wherein each lower switch is arranged in the lower switch region, and each upper switch region is arranged in the upper switch region.
wherein the first surface further comprises a first connecting line and a second connecting line, the first connecting line passes through the projections of the upper switch and the lower switch in the same switch bridge arm on the first surface, the second connecting line passes through the projections of the upper switch and the lower switch in the other switch bridge arm on the first surface, and the first connecting line intersects with the second connecting line.

Preferably, the first surface further comprises a middle switch region, and the middle switch region is arranged between the upper switch region and the lower switch region; and a middle switch of each switch bridge arm is arranged in the middle switch region.

Preferably, further comprises at least two flying capacitors, the first surface further comprises two flying capacitor regions; the two flying capacitor regions are arranged between the upper switch region and the lower switch region, and at least two flying capacitors are arranged in one flying capacitor region respectively; one end of each flying capacitor is electrically connected with the upper node of one switch bridge arm and the other end of each flying capacitor is electrically connected with the lower node of the other switch bridge arm.

Preferably, the two flying capacitor regions are respectively arranged on two opposite sides of the middle switch region.

Preferably, the power conversion device further comprises a transformer, the first surface further comprises a transformer region, the transformer is arranged in the transformer region, and the transformer region is arranged adjacent to the lower switch region.

In general, one aspect provides a power conversion device, comprising a winding substrate, a transformer and an inductor, wherein the winding substrate comprises a first surface and a second surface which are opposite to each other; and the first surface comprises a transformer region and an inductor region;
wherein the transformer comprises a transformer magnetic core and a transformer winding, the transformer magnetic core comprises two transformer winding channels, a first transformer winding channel side and a second transformer winding channel side, the two transformer winding channels penetrate through the first transformer winding channel side and the second transformer winding channel side, and the transformer winding passes through the transformer winding channel;
wherein the inductor comprises an inductor magnetic core and an inductor winding, the inductor magnetic core comprises two inductor winding channels, a first inductor winding channel side and a second inductor winding channel side, the two inductor winding channels penetrate through the first inductor winding channel side and the second inductor winding channel side, and the inductor winding passes through the inductor winding channel; the second transformer winding side is close to the first transformer winding side. The transformer winding and the inductor winding are electrically connected to the winding connection point, and the winding connection point is located between the second transformer winding channel side and the first inductor winding channel side

Preferably, the transformer winding comprises a first surface-mounted winding, a second surface-mounted winding and an internal winding, the first surface-mounted winding is arranged on the first surface, the second surface-mounted winding is arranged on the second surface, and the internal winding is arranged in the winding substrate.

Preferably, the winding substrate comprises at least one magnetic core hole groove and at least two through holes, the magnetic core hole groove penetrates through the first surface and the second surface, and the two through holes are used for being electrically connected with the first surface-mounted winding, the inner winding and the second surface-mounted winding.

Preferably, the first surface-mounted winding protrudes from the first surface, and the second surface-mounted winding protrudes from the second surface.

### BRIEF DESCRIPTION OF THE DRAWINGS

FIG. 1A to FIG. 1D are schematic diagrams of a topology diagram and the control strategy of a power conversion circuit;

FIG. 1E to FIG. 1F are schematic diagrams of another power conversion circuit topology and the corresponding control strategy schematic diagram;

FIG. 1G is a schematic diagram of winding of a magnetic assembly;

FIG. 1H to FIG. 1I are schematic diagrams of a control signal and a corresponding magnetic flux;

FIG. 2A is a schematic diagram of a power conversion circuit and a pre-charging circuit;

FIG. 2B is a schematic diagram of a power conversion circuit and a clamping circuit;

FIG. 3A is a schematic top surface layout diagram of a power conversion device;

FIG. 3B is a schematic diagram of a bottom surface layout of a power conversion device;

FIG. 3C is a schematic perspective exploded view of the power conversion device;

FIG. 3D is a schematic diagram of winding top surface of a winding of a power conversion device;

FIG. 3E is a side schematic diagram of a transformer winding of the power conversion device;

FIG. 3F to FIG. 3G are partial schematic diagrams of a top surface and a bottom surface of the power conversion device.

### DESCRIPTION OF THE EMBODIMENTS

The present application discloses various embodiments or examples of implementing the thematic technological schemes mentioned. To simplify the disclosure, specific instances of each element and arrangement are described below. However, these are merely examples and do not limit the scope of protection of this application. For instance, a first feature recorded subsequently in the specification formed above or on top of a second feature may include an embodiment where the first and second features are formed through direct contact, or it may include an embodiment where additional features are formed between the first and second features, allowing the first and second features not to be directly connected. Additionally, these disclosures may repeat reference numerals and/or letters in different examples. This repetition is for brevity and clarity and does not imply a relationship between the discussed embodiments and/or structures. Furthermore, when a first element is described as being connected or combined with a second element, this includes embodiments where the first and second elements are directly connected or combined with each other, as well as embodiments where one or more intervening elements are introduced to indirectly connect or combine the first and second elements.

One of the cores of the application is to provide a magnetic assembly, a power conversion circuit and a power conversion device. The capacitance value of the input capacitor is reduced through two or more circuit units connected in parallel with a staggered phase control strategy. Meanwhile, the volume of the magnetic assembly is reduced through a magnetic integration technology, parasitic parameters are reduced through the layout of the device, and the switching frequency of the power supply module is improved. The surface patch winding is arranged on the surface of the winding substrate, so that the parasitic resistance of the winding is reduced.

The application further provides a pre-charging circuit and a clamping circuit suitable for the power conversion circuit and various performances of the power conversion device are further optimized.

### Embodiment 1

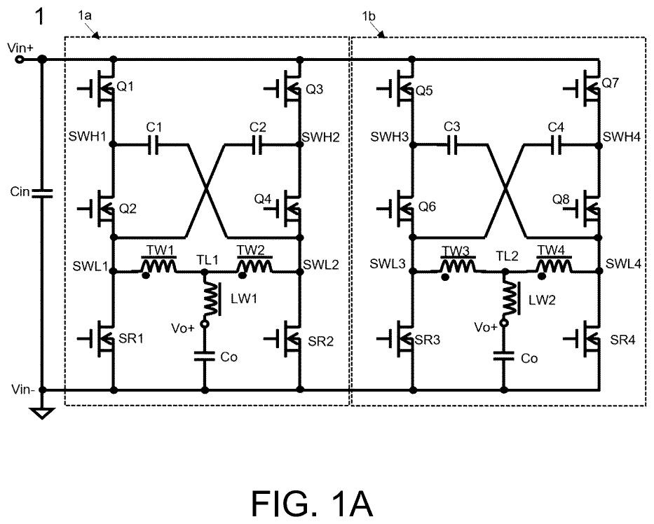

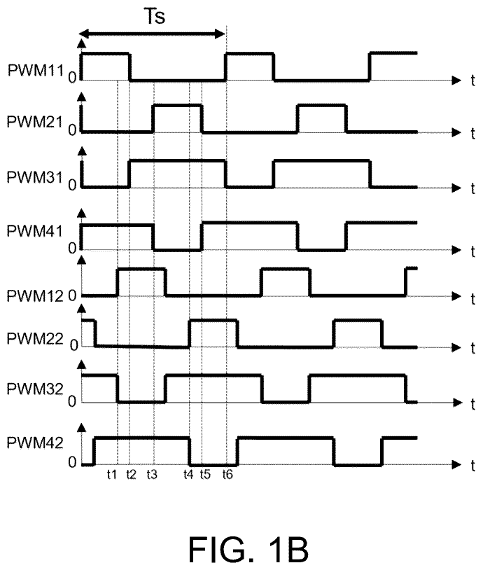

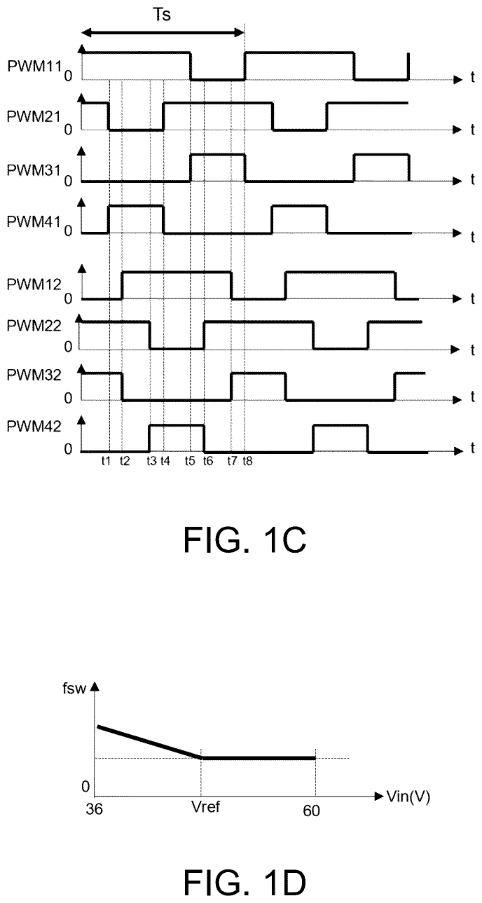

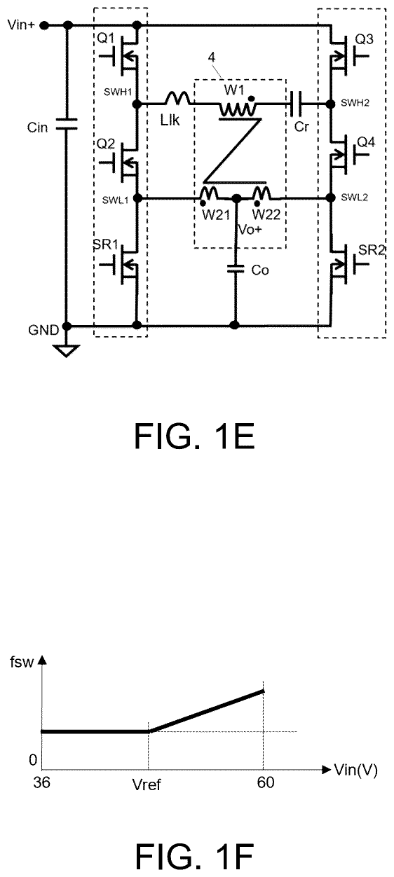

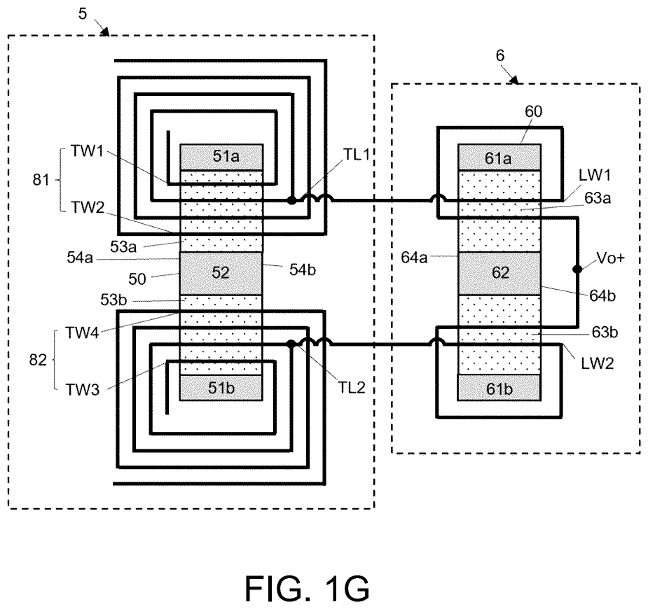

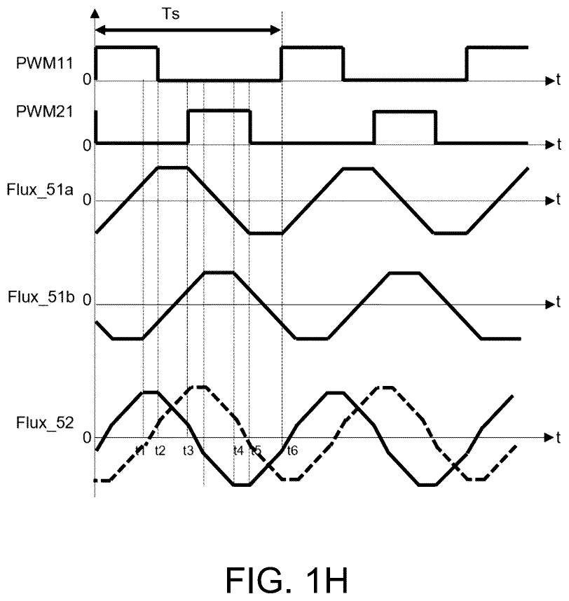

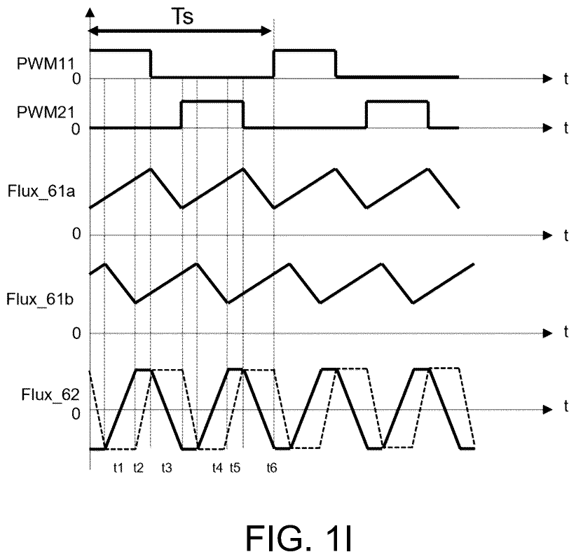

Embodiment 1 is showed as FIG. 1. The power conversion circuit comprises an input terminal Vin, an output terminal Vo, at least one input capacitor Cin, at least one output capacitor Co and two circuit units 1a and 1b, wherein the input terminal Vin comprises an input positive terminal Vin+ and an input negative terminal Vin−; the output terminal Vo comprises an output positive terminal Vo+ and an output negative terminal Vo−; the circuit unit 1a and the circuit unit 1b are electrically connected in parallel, and the input terminals of the two circuit units and the input capacitor Cin are connected in parallel bridging between the input positive terminal Vin+ and the input negative terminal Vin−; and the output terminals of the two circuit units and the output capacitor Co are connected in parallel bridging between the output positive terminal Vo+ and the output negative terminal Vo−. In the embodiment, the input negative terminal and the output negative terminal are short-circuited. Every circuit unit comprises six switches, one transformer, one inductor and two flying capacitors, wherein two upper switches Q1 and Q3, middle switches Q2 and Q4 and two lower switches SR1 and SR2, two flying capacitors C1 and C2. The transformer comprises a winding assembly 81. The winding assembly 81 comprises two transformer windings TW1 and TW2. The upper switch Q1, the middle switch Q2 and the lower switch SR1 are connected in series by order to be a tri-switches bridge arm. The upper switch Q3, the middle switch Q4 and the lower switch SR2 are connected in series by order to be a tri-switches bridge arm. The upper switch Q1 and the middle switch Q2 are electrically connected to the upper node SWH1, the middle switch Q2 and the lower switch SR1 are electrically connected to the lower node SWL1, the upper switch Q1 is electrically connected to the input positive terminal Vin+, the lower switch SR1 is electrically connected to the input negative terminal Vin−; the upper switch Q3 and the middle switch Q4 are electrically connected to the upper node SWH2, the middle switch Q4 and the lower switch SR2 are electrically connected to the lower node SWL2, the upper switch Q3 is electrically connected to the input positive terminal Vin+, the lower switch SR2 is electrically connected to the input negative terminal Vin−. The second end of the transformer winding TW1 and the second end of TW2 are electrically connected on the connected point TL1. The first end of the transformer winding TW1 is electrically connected to the lower node SWL1, and the first end of the transformer winding TW2 is electrically connected to the lower node SWL2. The first end of the transformer winding TW1 and the second end of the transformer winding TW2 are dotted terminals (i.e., the polarity of the dotted terminals are same) and are labeled as point ends. The first end of the inductor LW1 is electrically connected to the winding connection point TL1, the second end of the inductor LW1 is electrically connected to the output positive terminal Vo+, and the output capacitor Co is bridged between the output positive terminal Vo+ and the output negative terminal Vo− (i.e., the input positive terminal Vin−). Similarly, the circuit connection mode of the circuit unit 1b is the same as that of the circuit unit 1a, and details are not described again.

A control signal adopted by the power conversion circuit 1 is shown in FIGS. 1B and 1C, and comprises the first control signal group and the second control signal group. The first control signal group is used for opening and closing a corresponding switch in the circuit unit 1a, and the second control signal group is used for opening and closing a corresponding switch in the circuit unit 1b. The first control signal group comprises the first control signal PWM 11, the second control signal PWM 21, the third control signal PWM 31 and the fourth control signal PWM 41. The phase shift between the first control signal PWM 11 and the second control signal PWM 21 is 180 degrees, The third control signal PWM 31 is complementary to the first control signal PWM 11 and the fourth control signal PWM 41 is complementary to the second control signal PWM 21; the second control signal group comprises the first control signal PWM 12, the second control signal PWM 22, the third control signal PWM 32 and the fourth control signal PWM 42. The phase shift of the first control signal PWM 12 and the second control signal PWM 22 is 180 degrees. The third control signal PWM 32 is complementary to the first control signal PWM 12 and the fourth control signal PWM 42 is complementary to the second control signal PWM 22. The phase shift between each control signal in the first control signal group and a corresponding control signal in the second control signal group is 90 degrees, for example, the phase shift between the first control signal PWM 11 and the PWM 12 is 90 degrees, and the phase shift between the second control signal PWM 21 and the PWM 22 is 90 degrees.

Here, the control strategy of the embodiment is detailed by taking the circuit unit 1a as an example, and the control strategy of the circuit unit 1b is similar, so details are not described again. When the duty ratio of the control signal of the power conversion circuit 1 is less than or equal to 50% (ie, the duty ratio is of the first control signal of the upper switch Q1 and/or the second control signal for controlling the upper switch Q3), the first control signal PWM 11 controls the on and off of the upper switch Q1 and the middle switch Q4, and the second control signal PWM 12 controls the on and off of the upper switch Q3 and the middle switch Q2; The third control signal PWM 13 controls the on and off of the lower switch SR2 and the fourth control signal controls the on and off of the lower switch SR1. As shown in FIG. 1B, the moment 0 to t6 is one switching period Ts of the power conversion circuit.

When the duty ratio of the control signal of the power conversion circuit 1 is greater than 50%, the first control signal PWM 11 controls the on and off of the upper switch Q1 and the second control signal PWM 12 controls the on and off of the upper switch Q3. The third control signal PWM 13 controls the on and off of the middle switch Q2 and the lower switch SR2. The fourth control signal controls the on and off of the switch Q4 and the lower switch SR1.

In the embodiment, when the duty ratio of the upper switch is smaller than or equal to 50%, the middle switches Q2 and Q4 are turned-on and turned-off with the corresponding upper switches respectively, that is, the middle switch Q2 and the upper switch Q3 are turned-on and turned-off at the same time, and the middle switch Q4 and the upper switch Q1 are turned-on and turned-off at the same time. At the moment, the output voltage expression is Vo=Vin*D/2, wherein D is the duty ratio of the upper switch. When the duty ratio of the upper switch is larger than 50%, the middle switches Q2 and Q4 are turned-on and turned-off with the corresponding lower switches respectively, that is, the middle switch Q2 and the lower switch SR2 are turned-on and turned-off at the same time, and the middle switch Q4 and the lower switch SR1 are turned-on and turned-off at the same time. At the moment, the output voltage expression is Vo=Vin*D/2, wherein D is the duty ratio of the upper switch. According to the control mode, the output voltage is in direct proportion to the duty ratio of the upper switch, so that when the input voltage is smaller than 48V, the duty ratio of the upper switch is greater than 50%, and the output voltage can maintain 12V.

According to the embodiment of the application, the control strategy of the phase shift 90 degrees of the circuit unit 1a and the circuit unit 1b is adopted. Comparing with a traditional control strategy using circuit units 1a and 1b with non-phase shift, under the condition that the input capacitor Cin ripple voltage amplitude is the same, the frequency of the input capacitor Cin ripple voltage of the non-phase shift control strategy is doubled. If the amplitudes of the ripple current under phase shift control strategy and under the non-phase shift control strategy, the inductance of the input inductor can be halved and the volume of the input inductor is reduced under the phase shift control strategy. On the other hand, the input pin of the power conversion device is connected with an internal input capacitor Cin1 of the power conversion device and an external input capacitor Cin2 of the power conversion device and an equivalent parasitic inductance Lk exists in the loop. Furthermore, the external input inductor of the power conversion device can be removed, the input filter only comprises the internal input capacitor Cin1 and the equivalent parasitic inductance Lk. The resonant frequency fr of the input filter can be obtained by formula (1):

$$f r = \frac{1}{2 π \cdot sqrt ( Lk \cdot Cin 1 )}$$

Meanwhile, the resonant frequency and the switching frequency meet the condition that fr is smaller than or equal to 2.5*fsw, and even fr is smaller than or equal to 2*fsw. The fsw is the switching frequency of the power conversion device. Therefore, for the power conversion device, the frequency of the input current is 4*fsw, and after the input current is filtered by the input capacitor Cin and the equivalent parasitic inductance Lk, the ripple current amplitude flowing through the equivalent parasitic inductance Lk and the external input capacitor Cin2 of the power conversion device is greatly attenuated. In the embodiment, the phase number of the t unit is taken 2 as an example. Certainly, the phase number of the circuit unit can be greater than 2, and if the phase number of the circuit unit is N (N is an integer greater than or equal to 2), the phase difference of the N-phase circuit units is 180/N, the resonant inductor fr of the input filter meets fr≤1.25 N*fsw, even fr≤N*fsw. According to the embodiment of the application, the power conversion device can also be one or more power supply modules, and when the multi of power supply modules are connected in parallel, the phase shift control strategy can also be adopted between each power supply module and the technical features and advantages can be referred to the above embodiment.

The resonant frequency of the input filter should be bigger than fb, fb is the crossover frequency of the closed loop of the power supply module. When the frequency of interruption current received by the power supply module is equal to the resonant frequency fr, the input capacitor Cin and the equivalent parasitic inductance Lk parallelly resonant and the input filter is in high impedance state. But under the frequency of the interruption current, the power supply module is in a state of open loop, and the parallel resonant can't trigger the oscillation of the power supply module.

In FIG. 1C, the interval from the moment 0 to t8 is a switching period Ts of the power conversion circuit. In the intervals from the moment 0 to t1 and from the moment t4 to t5, the upper switch Q1 and Q3 are in the on state, the flying capacitor C1 and C2 are in the charge state, and the input capacitor Cin is in discharge state. At the moment t1 (i.e., when Q3 is turned off), or at the moment t5 (ie, when Q1 is turned off), the flying capacitors C1 and C2, the input capacitor Cin and the corresponding switches are formed a capacitor loop. If the sum of the voltages of the flying capacitor C1 and C2 (Vc1+Vc2) is bigger than the voltage of input capacitor Cin (Vcin), the voltage imbalance in the capacitor loop will occur, the inrush current and the power loss are generated. In order to reduce the inrush current, at the moment t1 or t5, the capacitance voltage difference between (Vc1+Vc2) and Vcin can be reduced.

In order to reduce the capacitance voltage difference at the moment t1 or t5, two technical solutions are disclosed. One solution is paralleled two circuit units and phase shift 90 degree between the circuit unit 1a and circuit unit 1b. Comparing with the non-phase shift control strategy, with the phase shift control strategy, in the interval of 0 to t1 and t4 to t5, the amplitude of the discharge current of the input capacitor Cin is reduced to 50% or below, the voltage amplitude of the input capacitor Cin is reduced to 50% or below. Through reducing the voltage amplitude of the input capacitor Cin, the capacitance voltage difference is reduced, the voltage unbalance in the capacitor loop is reduced, and the inrush current and the power loss are reduced correspondingly. On the other hand, with the phase shift control strategy, in the interval of 0 to t1 and t4 to t5, keeping the same voltage amplitude of the input capacitor Cin, the number of input capacitor Cin can be reduced.

In order to reduce the capacitance voltage difference at the moment t1 or t5, another technical solution is disclosed as shown in FIG. 1D. Within an input voltage range of the duty cycle less than 50% (i.e., Vin is less than a reference voltage Vref, such as Vref=48V), increasing the switching frequency of the power conversion circuit can make the amplification of the superposition voltage (Vc1+Vc2) of the flying capacitors C1 and C2 reduced, and the amplitude of the voltage of the input capacitor Vcin reduced. So that the voltage difference of the capacitor loop can be reduced and the voltage imbalance in the capacitor loop can be reduced in the interval of 0 to t1 and t4 to t5. Correspondingly, the current impact caused by the imbalance of the voltage is also greatly reduced, so that the loss is greatly reduced. Further, when the input voltage Vin is smaller than the voltage range of Vref, the switching frequency fsw increases linearly with the linear decrease of the input voltage Vin; and the stability and reliability of the operation of the power conversion device can be improved by using the linear change of the switching frequency fsw along with the input voltage Vin. The control strategy disclosed in this technical solution has the advantages that: 1) in the voltage range of which the input voltage Vin is greater than the reference voltage Vref, a lower switching frequency is used, the switching loss is small, and the conversion efficiency of the power conversion device is high; 2) in the voltage range of which the input voltage Vin is smaller than the reference voltage Vref, the duty ratio of the upper switch is greater than 50% and increases along with the drop of the input voltage, a stable output voltage is obtained, and the impact current loss caused by unbalanced voltage in the capacitor loop is reduced due to the fact that the switching frequency is increased along with the decrease of the input voltage. Similarly, the control strategy of the circuit unit 1b and the second control signal group are similar to the control strategy of the circuit unit 1a and the first control signal group, and details are not described again.

Within a certain voltage conversion range, the control strategy of the switching frequency fsw following the change of the input voltage Vin, not only can be applied to the bus converter with variable gain, but also can be applied to the bus converter with fixed gain. Referring to the schematic circuit diagram shown in FIG. 1E, the gain of bus converter is fixed to N: 1. Compared with any circuit unit in the circuit topology shown in FIG. 1A, the same feature is that six switches are used, and the connection modes of the six switches are the same. The difference is that the schematic circuit diagram comprises a transformer and a resonant capacitor Cr, and the transformer comprises a high-voltage winding W1 and two low-voltage windings W21 and W22. The high-voltage winding W1 and the resonant capacitor Cr are connected in series between the two upper nodes SWH1 and SWH2. The second ends of the two low-voltage windings W21 and W22 are electrically connected to the output positive terminal Vo+, and the first ends of the two low-voltage windings W21 and W22 are electrically connected to the two lower nodes SWL1 and SWL2 respectively. The resonant inductor Llk may be an external inductor connected in series with the resonant capacitor Cr and the high-voltage winding W1 between the two upper nodes, or may be the sum of the parasitic leakage inductance of the transformer and the parasitic inductance. In this embodiment, the switching frequency fsw changes along with the change of the input voltage Vin, as shown in FIG. 1F. The specific control strategy is that when the input voltage Vin is greater than the reference voltage Vref, the switching frequency fsw increases linearly along with the increase of the input voltage Vin. In this embodiment, the reference voltage Vref may be any value between 52V and 60V, for example, 52V. The control strategy may achieve that when the input voltage Vin increases linearly, the switching frequency fsw is also linearly increased, so that the alternating current magnetic density of the transformer magnetic core remains constant, thereby the magnetic core loss of the transformer is effectively reduced.

The power conversion device adopting the circuit shown in FIG. 1A and the control strategy shown in FIG. 1B and FIG. 1C comprises a transformer assembly 5 and an inductor assembly 6, as shown in FIG. 1G. The transformer assembly 5 comprises a magnetic core 50, transformer windings TW1, TW2, TW3 and TW4, the magnetic core 50 comprises two magnetic substrates (not shown), two transformer side columns 51a and 51b and a transformer middle column 52, the two transformer side columns 51a and 51b and one transformer middle column 52 are arranged between the two magnetic substrates, and the two transformer side columns 51a and 51b and the transformer middle column 52 are sequentially arranged according to the sequence of the side columns, the middle columns and the side columns. A channel between the transformer middle column 52 and the transformer side column 51a is a transformer winding channel 53a, and a channel between the transformer middle column 52 and the transformer side column 51b is a transformer winding channel 53b; The magnetic core 50 further comprises two opposite sides, namely a first transformer winding channel side 54a and a second transformer winding channel side 54b. The transformer winding channel 53a and the transformer winding channel 53b both penetrate through the first transformer winding channel side 54a and the second transformer winding channel side 54b. The first ends of the transformer windings TW1 and TW2 in the winding combination 81 are arranged on the first transformer winding channel side 54a, and the second ends are arranged on the second transformer winding channel side 54b, that is, the second ends of the transformer winding TW1 and TW2 are electrically connected to the winding connection point TL1 located on the second transformer winding channel side 54b of the magnetic core 50. The transformer winding TW1 passes through the transformer winding channel 53a twice in a first direction (as shown in FIG. 1G from left to right) from the first end to the second end; i.e., is wound around the side column 51a in a counterclockwise direction. The transformer winding TW2 passes through the transformer winding channel 53a twice from the first end to the second end in a second direction (as shown in FIG. 1G from right to left) passing through the transformer winding channel 53a twice; i.e., is wound around the transformer side column 51a in a clockwise direction. Two transformer windings in the winding assembly 81 pass through the transformer winding channel 53a in different directions. The first ends of the transformer windings TW3 and TW4 in the winding assembly 82 are arranged on the first transformer winding channel side 54a, and the second ends of the transformer windings TW3 and TW4 are arranged on the second transformer winding channel side 54b. That is, the second ends of the transformer winding TW3 and TW4 are electrically connected to the winding connection point TL2, located on the second transformer winding channel side 54b of the magnetic core 50. The transformer winding TW3 passes through the transformer winding channel 53b twice in a first direction (as shown in FIG. 1D from left to right) from the first end to the second end; i.e., is wound around the transformer side column 51b in a clockwise direction. The transformer winding TW4 passes through the transformer winding channel 53b twice in a second direction (as shown in FIG. 1D from right to left) from the first end to the second end. That is, the transformer winding TW4 is wound around the transformer side column 51b in a counterclockwise, and the two transformer windings in the winding assembly 82 pass through the transformer winding channel 53b in different directions.

The winding mode of the transformer winding shown in the FIG. 1G interacts with the control mode of FIG. 1B or FIG. 1C, so that the phase shift between the voltage waveforms of the two ends of the windings on each side column is 90 degrees; and in the magnetic core 50, the direct-current magnetic flux value flowing through each magnetic column is approximately zero. The schematic diagram of the alternating-current magnetic flux flowing through the transformer side column 51a changes along with time is shown in the FIG. 1H, and the Flux_51a is the alternating-current magnetic flux generated by the transformer winding Tw1 and Tw2 on the side column 51a. The schematic diagram of the alternating-current magnetic flux flowing through the transformer side column 51b changes along with time is shown in the FIG. 1H, and the Flux_51b is the alternating-current magnetic flux generated by the transformer windings Tw3 and Tw4 on the transformer side column 51b. The phase shift between the two alternating-current Flux_51a and Flux_51b flowing through the transformer side columns along with time is 90 degrees, the two alternating-current Flux_51a and Flux_51b flowing through the transformer side columns are subtracted according to the phase on the transformer middle column 52, and the schematic diagram of the alternating-current Flux_51a and Flux_51b flowing through the transformer side columns along with time is shown as Flux_52 (solid line). On the other hand, the winding direction of the transformer winding can be changed, so that the alternating-current magnetic fluxes flowing through the two side columns are superposed according the phase on the transformer middle column 52, and the schematic diagram of the alternating-current magnetic flux changing along with time is shown as Flux_52 (dotted line); the alternating-current magnetic flux values shown by solid lines and dotted lines are the same, the phase shift is 90 degrees, and the frequency of the alternating-current magnetic flux shown by solid lines or dotted lines is the same as the frequency of the alternating-current magnetic flux flowing through the side columns. According to the transformer assembly 5, the transformer in the circuit unit 1a and the transformer in the circuit unit 1b are integrated in one magnetic core 50, the size of the magnetic core is reduced, the number of magnetic cores in the power conversion device is reduced, and therefore the complexity of magnetic core assembly is reduced. When the duty ratio D is less than 0.5, the alternating current magnetic flux amplitude flowing through the middle column is greater than the alternating current magnetic flux amplitude flowing through any side column and smaller than twice the alternating current magnetic flux amplitude flowing through any side column; and when the duty ratio D is equal to 0.5, the amplitude of the alternating current magnetic flux flowing through the middle column is equal to the alternating current magnetic flux amplitude flowing through any side column, so that the purpose of reducing the overall loss of the magnetic core is achieved.

In FIG. 1G, the first ends of the transformer winding TW1/TW2/TW3/TW4, the second ends of the transformer winding TW1/TW2/TW3/TW4, the first ends of the inductor winding LW1/LW2, and the second ends of the inductor winding LW1/LW2 are sequentially placed along the long axis direction of the power supply module and further sequentially placed along the input terminal to the output terminal of the power supply module, so that the second ends of the transformer winding TW1/TW2/TW3/TW4 are adjacent to the second ends of the inductor winding LW1 and LW2; The path of the power current flowing from the first end (input terminal) of the transformer to the second end (output terminal) of the inductor is the shortest, the path of the power current flowing from the input terminal of the power supply module to the output terminal of the power supply module is the shortest, and the advantages of minimum parasitic resistance and minimum conduction loss of the power current path winding are obtained.

Referring again to FIG. 1G, the inductor assembly 6 comprises a magnetic core 60, and the inductor windings LW1 and LW2. Magnetic cores 60 comprise two magnetic substrates (not shown), two inductor side columns 61a and 61b, and an inductor middle column 62, wherein the two inductor side columns 61a and 61b and one inductor middle column 62 are arranged between the two magnetic substrates and are sequentially arranged according to the sequence of the side column, the middle column and the side column; A channel between the inductor middle column 62 and the inductor side column 61a is a inductor winding channel 63a, and a channel between the inductor middle column 62 and the inductor side column 61b is an inductor winding channel 63b; The magnetic core 60 further comprises two opposite sides, namely a first inductor winding channel side 64a and a second inductor winding channel side 64b. The inductor winding channel 63a and the inductor winding channel 63b. The first ends of the inductor windings LW1 and LW2 are adjacent to the first inductor winding channel side 64a, and the second ends are adjacent to the second inductor winding channel side 64b; that is, the intersection point Vo+ of the second ends of the inductor windings LW1 and LW2 is located on the second inductor winding channel side 64b of the magnetic core 60. The inductor winding LW1 passes through the inductor winding channel 63a twice from the first end to the second end in a first direction (as shown in FIG. 1G from left to right); i.e., is wound around the inductor side column 61a in a counterclockwise direction; The inductor winding LW2 passes through the inductor winding channel 63b twice from the first end to the second end in a first direction (as shown in FIG. 1G from left to right), that is, the inductor winding LW2 is wound around the inductor side column 61b in the clockwise direction, and the two inductor windings respectively pass through the corresponding winding channels in the same direction.

As shown in FIG. 1G, the winding mode of the inductor winding and the control mode of FIG. 1B or FIG. 1C interact together, so that the phase shift between the voltage waveforms of the two ends of the windings on each side column is 90 degrees, and in the magnetic core 60, the direct-current magnetic flux flowing through each side column is counteracted on the inductor middle column 62, so that the direct-current magnetic flux value flowing through the inductor middle column 62 can be approximately zero; The schematic diagram of the alternating-current magnetic flux flowing through the inductor side column 61a changes along with time is shown in FIG. 1I, and the Flux_61a is the alternating-current magnetic flux generated by the inductor winding LW1 on the inductor side column 61a; The schematic diagram of the alternating-current magnetic flux flowing through the inductor side column 61b changing along with time is shown in FIG. 1F, and the Flux_61b is the alternating-current magnetic flux generated by the inductor winding LW2 on the inductor side column 61b; The phase shift between the two alternating-current magnetic flux Flux_61a and Flux_61b flowing through the inductor side columns along with time is 90 degrees, the two alternating-current magnetic flux Flux_61a and Flux_61b flowing through the inductor side columns are subtracted according to the phase on the inductor middle column 62, and the schematic diagram of the alternating-current magnetic flux Flux_61a and Flux_61b flowing through the inductor side columns along with time is shown as the Flux_62 (solid line) in FIG. 1I. According to the inductor assembly 6, the inductor in the circuit unit 1a and the inductor in the circuit unit 1b are integrated in one magnetic core 60, and the magnetic core 60 is made of an iron powder material, so that the size of the magnetic core is reduced, the number of magnetic cores in the power conversion device is reduced, and the complexity of magnetic core assembly is reduced. When the duty ratio D is less than 0.5, the alternating current magnetic flux amplitude flowing through the middle column is greater than the alternating current magnetic flux amplitude flowing through any side column and smaller than twice the alternating current magnetic flux amplitude flowing through any side column; and when the duty ratio D is equal to 0.5, the amplitude of the alternating current magnetic flux flowing through the middle column is equal to the alternating current magnetic flux amplitude flowing through any side column, so that the purpose of reducing the overall loss of the magnetic core is achieved.

As shown in FIG. 1G, the three magnetic columns in the transformer magnetic core 50 or the inductor magnetic core 60 can be independently formed with the two magnetic substrates, and can also be integrally formed with one of the magnetic substrates, or each of the three magnetic columns is divided into two parts, and each part is integrally formed with one magnetic substrate. The section, connected with the magnetic substrate, of the magnetic column of the transformer magnetic core 50 or the inductor magnetic core 60 can be rectangular, square, circular or oval and the like, and is not limited accordingly. The switch disclosed by the application can be Si MOSFET, SiC MOSFET, GaN MOSFET or IGBT MOSFET etc., and can realize the functions of the switch disclosed by the application.

As shown in FIG. 1A, the circuit unit 1a and 1b, the circuit unit can also be a four-switch circuit unit composed of an upper switch Q1, a middle switch Q2, a lower switch SR1 and SR2, a flying capacitor C1, a transformer and an inductor, and compared with the six-switch circuit unit 1a, the four-switch circuit unit which do not comprise the upper switch Q3, the middle switch Q4 and the flying capacitor C2. The four-switch circuit unit can also be connected in parallel by adopting two circuit units, and the control signal of each switch is the same as the control signal of the corresponding switch of the six-switch circuit unit. The magnetic core structure and the winding method of the transformer and the inductor of the four-switch circuit unit and the magnetic core structure and the winding method of the transformer and the inductor of the six-switch circuit unit can also obtain the same technical effect.

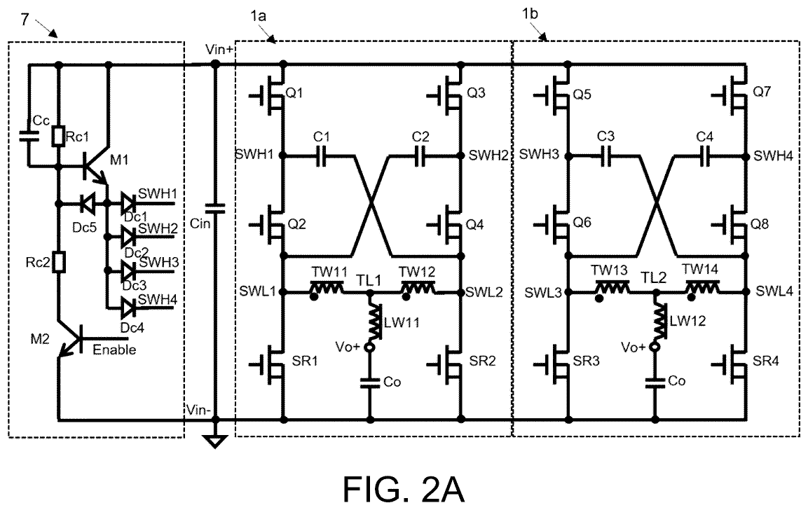

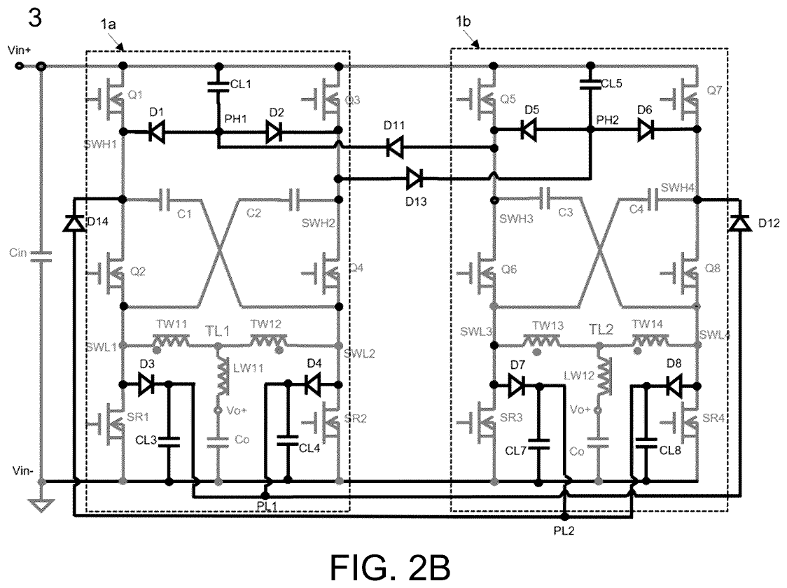

In the power conversion device disclosed in this invention, because of the existence of the flying capacitor C1/C2/C3/C4, when the power conversion device starts, the voltages of the flying capacitors C1 and C4 are zero. At the moment of the switches turned-on, the capacitance voltage difference between the zero voltage of the flying capacitors and the voltage of the input capacitor is the largest, a large impact current is generated on the switches. In order to avoiding the damage of the switches caused by the impact current, a pre-charge circuit 7 is disclosed, as shown in FIG. 2A. The pre-charge circuit 7 comprises a charging triode M1, an enabling triode M2, four charging diode Dc1/Dc2/Dc3/Dc4, a protection diode Dc5, two dividing resistors Rc1/Rc2 and a charging differential capacitor Cc. Here, the triode M1 and M3 can be NPN triode or N-type field-effect transistor. The collector of the charging triode M1 is electrically connected with the input positive Vin+, the emitter of the charging triode M1 is electrically connected with the positive electrodes of the four charging diode Dc1/Dc2/Dc3/Dc4 and the protection diode Dc5, the negative electrode of the protection diode Dc5 is electrically connected with the base electrode of the charging triode, the negative electrodes of the four charging diode Dc1/Dc2/Dc3/Dc4 are respectively electrically connected with an upper node. For example, the negative electrode of Dc1 is electrically connected with the upper node SWH1, the negative electrode of Dc2 is electrically connected with the upper node SWH2, the negative electrode of Dc3 is electrically connected with the upper node SWH3, and the negative electrode of Dc4 is electrically connected with the upper node SWH4. One end of the resistor Rc1 and the resistor Rc2 is electrically connected with the base electrode of the charging triode M1, the other end of the voltage dividing resistor Rc1 is electrically connected with the input positive terminal Vin+, and the other end of the voltage dividing resistor Rc2 is electrically connected with the collector electrode of the enabling triode M2. The emitter of the enable triode M2 is electrically connected with the input negative terminal Vin−, and the base electrode of the enable triode M2 is electrically connected with an enable control signal ENABLE. The charging differential capacitor Cc is electrically connected with the divider resistor Rc in parallel. The protection diode Dc5 is used for protecting the PN junction of the charging triode M1, and the charging diode Dc1-Dc4 can prevent energy backflow of the flying capacitor C1/C2/C3/C4.

When the control signal ENABLE control the enable triode M2 to be turned off, the charging triode M1 is turned on to charge the flying capacitor; and when the control signal ENABLE controls the enabling triode M2 to be turned on, the base electrode and the emitter electrode of the charging triode M1 bear the reverse voltage and then the charging triode M1 is turned off, and the pre-charging is stopped. When the input voltage Vin is connected to the power conversion device, the terminal voltages at the two ends of the flying capacitor C1/C2/C3/C4 are zero, and the base voltage of the charging triode M1 rises, so that the charging triode M1 charges the four flying capacitors C1/C2/C3/C4 through the four charging diodes Dc1/Dc2/Dc3/Dc4 respectively, that is, the node voltages of the four upper nodes SWH1/SWH2/SWH3/SWH4 rise. When the terminal voltages at the two ends of the flying capacitor C1/C2/C3/C4 rise to Vin/2 (i.e., the node voltage rising to Vin/2 of the four upper nodes SWH1/SWH2/SWH3/SWH4), the control signal ENABLE is turned over (such as by triggering a comparator to enable the control signal ENABLE to turn over), so that the enabling triode M2 is turned on, the base voltage of the charging triode M1 is reduced and less than Vin/2, the charging triode M1 is turned off, and the pre-charging process is finished. At the moment, the switches of the power conversion device can be sequentially turned on, so that the power conversion device enters a stable working state. If the power conversion device is not turned on and the terminal voltage at the two ends of the flying capacitor C1/C2/C3/C4 drops below Vin/2, the enabling triode M2 is turned off again by the control signal ENABLE, so that the charging triode M1 is turned on again to charge the flying capacitor C1/C2/C3/C4.

Before the power conversion device is started, the output initial voltage is not zero, that is, when a bias voltage Vbias exists, the threshold voltage of the comparator enabling the control signal ENABLE to turn over can be set to be (Vin/2+Vbias). When the input voltage Vin is connected to the power conversion device, the enabling triode M2 is also turned off, so that the charging triode M1 is turned on to charge the flying capacitor, and when the voltage across the flying capacitor C1/C2/C3/C4 rises to Vin/2 (i.e., the node voltage of the upper node SWH1/SWH2/SWH3/SWH4 is Vin/2+Vbias), the comparator is triggered to enable the control signal ENABLE to be turned over, so that the enabling triode M2 is turned on, the base voltage of the charging triode M1 is reduced, less than (Vin/2+Vbias), the charging triode M1 is turned off, and the pre-charging process is finished. At the moment, the switches of the power conversion device can be sequentially turned on, so that the power conversion device enters a stable working state. If the power conversion device is not turned on and the voltage across the flying capacitor C1/C2/C3/C4 drops below Vin/2, the enabling triode M2 is turned off by the control signal ENABLE, so that the charging triode M1 is turned on again to charge the flying capacitor C1/C2/C3/C4.

The differential capacitor Cc and the divider resistor Rc1 are electrically connected in parallel, and when the enabling triode M2 is turned on, the differential capacitor Cc, the divider resistor Rc1 and the Rc2 form a differential circuit, so that the base voltage of the charging triode M1 can quickly track the change of the input voltage Vin. Furthermore, the voltages cross the flying capacitor C1/C2/C3/C4 can quickly track the change of the input voltage Vin. According to the circuit, the voltages of the two ends of the upper switch Q1 and Q3 can be reduced from Vin to Vin/2. In this way, the switch with the rated withstand voltage larger than or equal to 0.6*Vin or larger than or equal to 0.7*Vin can be selected as the upper switch, the on-resistance of the switch can be effectively reduced by selecting the switch with low rated withstand voltage, and the conversion efficiency of the power conversion device is improved. In addition, M1 and M2 in the pre-charging circuit disclosed by the application are not limited to triodes, and can also be replaced by other switches as long as the same function can be realized.

As shown in FIG. 1A, each bridge arm comprises three switches, so that the loop formed by each bridge arm and the input capacitor is large. The peak voltage generated in the turn-off process of the switch is also correspondingly increased, especially the lower switch. As shown in FIG. 2B, the two ends of the upper switch and the two ends of the lower switch of each circuit unit are electrically connected with one clamping circuit, so that damage to the switch caused by peak voltage generated in the switching-off process of the switch is avoided. Each clamping circuit comprises an absorption circuit and a discharge circuit, the absorption circuit is used for absorbing peak voltages at the two ends of the switch, and the discharge circuit can return energy absorbed by the absorption circuit to the flying capacitor of the power conversion circuit so as to reduce the power loss. The two ends of the upper switch Q1 in the circuit unit 1a are electrically connected with an absorption circuit in parallel, the absorption circuit comprises an absorption diode D1 and an absorption capacitor CL1. The positive electrode of the absorption diode D1 and the first end of the absorption capacitor CL1 are electrically connected in series to the point PH1, the second end of the absorption capacitor CL1 is electrically connected with the input positive terminal Vin+, and the negative electrode of the absorption diode D1 is electrically connected with the upper node SWH1. The discharging circuit comprises a discharging diode D11, the negative end of the discharging diode D11 is electrically connected with the point PH1, and the positive end of the discharging diode D11 is electrically connected with an upper node SWH3 in the circuit unit 1b. The two ends of the upper switch Q3 in the circuit unit 1a are electrically connected with an absorption circuit in parallel, the absorption circuit comprises an absorption diode D2 and an absorption capacitor CL1. The absorption circuit of the upper switch Q1 and the absorption circuit of the upper switch Q3 in the circuit unit 1a share one absorption capacitor CL1. The positive electrode of the absorption diode D2 and the first end of the absorption capacitor CL1 are electrically connected in series to the point PH1. The second end of the absorption capacitor CL1 is electrically connected with the input positive terminal Vin+, and the negative electrode of the absorption diode D2 is electrically connected with the upper node SWH2. The discharge circuit comprises a discharge diode D11, that is, the upper switches Q1 and Q3 share one discharge diode. When the upper switch Q1 or the upper switch Q3 is turned off, the peak voltage generated instantly is absorbed by the absorption capacitor CL1. When the SR4 is turned on, the absorption capacitor CL1 discharges Cin and C3 through the SR4 and D11, so that the voltage of the CL1 is close to the difference between the Cin voltage and the C3 voltage, the voltage of the CL1 is approximately Vin/2, and the CL1 can absorb the peak voltage generated by turning off the upper switch Q1 or the upper switch Q3 of the next switching period. In other embodiments, the positive terminal of the discharge diode D11 can also be electrically connected to the upper node SWH4 in the circuit unit 1b or the upper node SWH1 or SWH2 in the circuit unit 1a.

Two ends of the lower switch SR1 in the circuit unit 1a are electrically connected with an absorption circuit in parallel, the absorption circuit comprises an absorption diode D3 and an absorption capacitor CL3. The negative electrode of the absorption diode D3 and the first end of the absorption capacitor CL3 are electrically connected in series to the point PL1. The second end of the absorption capacitor CL3 is electrically connected to the input negative terminal Vin−, the positive electrode of the absorption diode D3 is electrically connected with the lower node SWL1. The discharge circuit comprises a discharge diode D12, the positive end of the discharge diode D12 is electrically connected with the point PL1, and the negative end of the discharge diode D12 is electrically connected with the upper node SWH4 in the circuit unit 1b. The two ends of the lower switch SR2 are electrically connected with an absorption circuit in parallel, the absorption circuit comprises an absorption diode D4 and an absorption capacitor CL4, the negative electrode of the absorption diode D4 and the first end of the absorption capacitor CL4 are electrically connected in series to the point PL1s, the second end of the absorption capacitor CL4 is electrically connected with the input negative terminal Vin−, and the positive electrode of the absorption diode D4 is electrically connected with the lower node SWL2. The discharge circuit comprises a discharge diode D12, that is, the lower switch SR1 and SR2 share one discharge diode. When the lower switch SR1 or the lower switch SR2 is turned off, the peak voltage generated instantly is absorbed by the absorption capacitor CL3 or CL4, and when the SR3 is turned on, the absorption capacitor CL3 or CL4 discharges C4 through D12 and SR3, so that the voltage of CL3 or CL4 is close to the voltage of C4, and CL3 or CL4 can also absorb the peak voltage generated by turning off the lower switch SR1 or the lower switch SR2 of the next switching period. The absorption circuit of the upper switch or the lower switch of each switch can share one absorption capacitor, and can also be used as the absorbing capacitors CL3 and CL4, each switch is provided with an absorption capacitor nearby, and the absorption circuit can be specifically set according to the layout of the upper switch or the lower switch. In other embodiments, the negative end of the discharge diode D12 is also electrically connected to the upper node SWH3 in the circuit unit 1b or the upper node SWH1 or SWH2 in the circuit unit 1a.

Similarly, the absorption circuit of the upper switch of the circuit unit 1b is as shown in the circuit unit 1a, the negative end of the discharge diode D13 is electrically connected with the point PH2, and the positive end of the discharge diode D13 is electrically connected with the upper node SWH2 of the circuit unit 1a. The absorption circuit of the lower switch of the circuit unit 1b is as shown in the circuit unit 1a, the positive end of the discharge diode D14 is electrically connected with the PL2, and the negative end of the discharge diode D14 is electrically connected with the upper node SWH1 of the circuit unit 1a. In the embodiment, the clamping circuits are arranged at the two ends of the corresponding switch of the power conversion circuit, so that the peak voltage generated by turning off the corresponding switch is clamped, and the switch is protected from being damaged by the peak voltage; And meanwhile, the absorbed peak energy is sent back to the flying capacitor of the other circuit unit, so that the conversion efficiency of the power conversion circuit is improved.

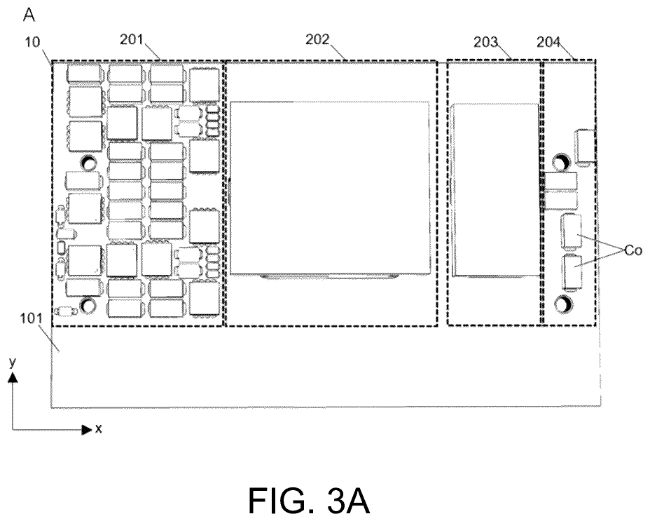

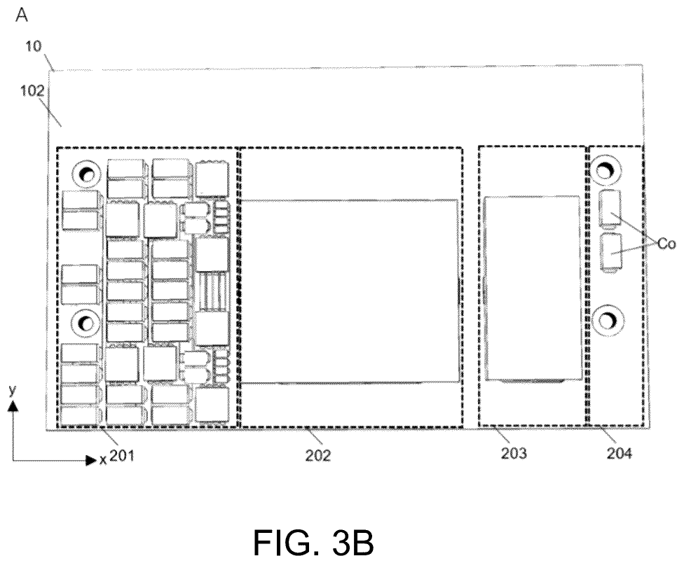

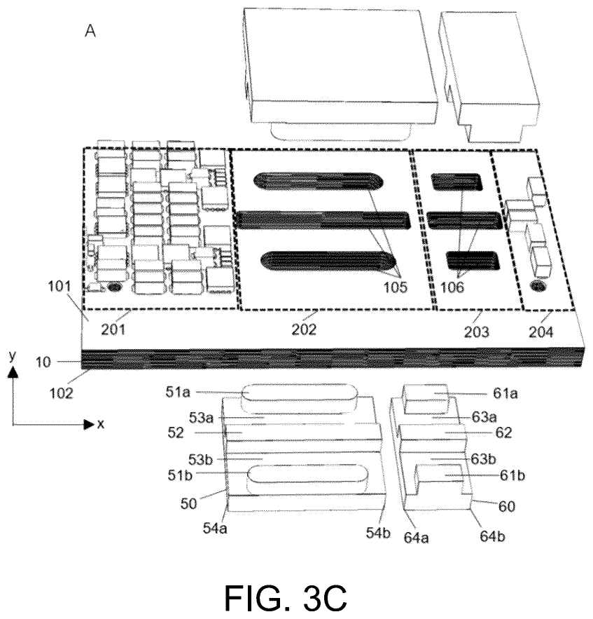

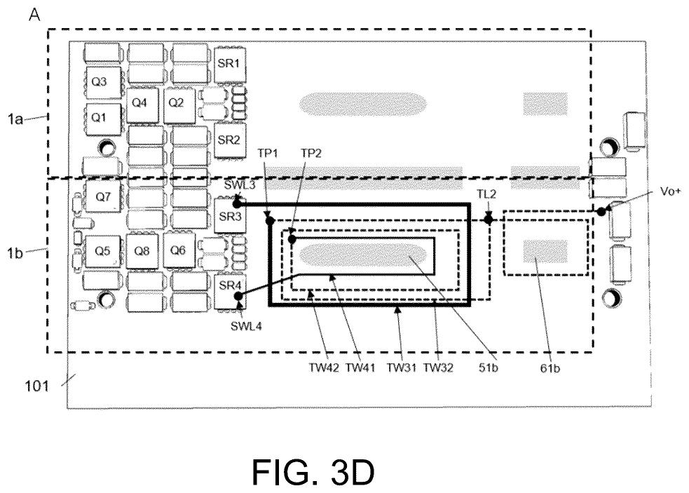

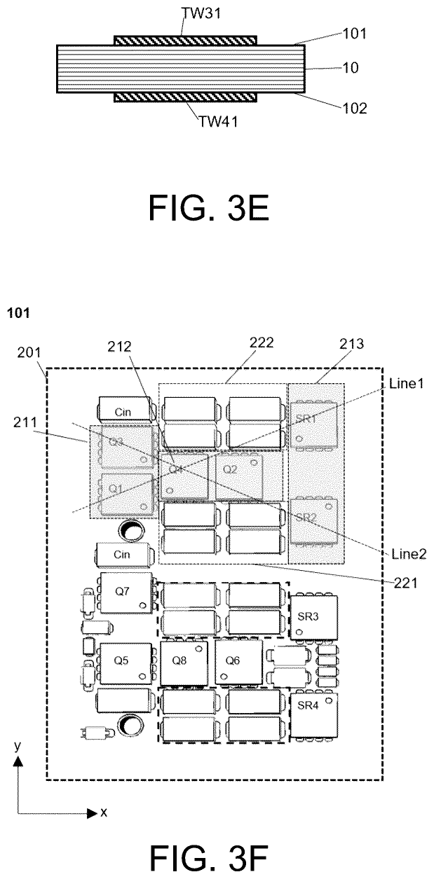

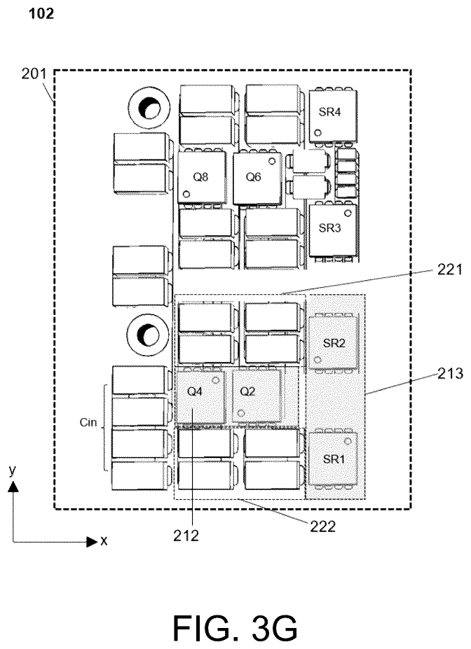

The layout of the power conversion device adopting the circuit topology is shown in FIG. 3A to FIG. 3C. FIG. 3A is a top surface layout schematic diagram of the power conversion device, FIG. 3B is a bottom surface layout schematic diagram of the power conversion device, and FIG. 3C is a three-dimensional explosion schematic diagram of the power conversion device. The power conversion device A comprises a winding substrate 10, and a transformer magnetic core 50, an inductor magnetic core 60, a plurality of switches, a plurality of capacitors and the like which are arranged on the winding substrate 10. The winding substrate 10 comprises a first surface 101 and a second surface 102 opposite to each other, and the first surface 101 comprises a power circuit region 201, a transformer region 202, an inductor region 203, and an output pin region 204. A switching device, a capacitor device and the like in each circuit unit are arranged on the power circuit region 201. The transformer magnetic core 50 is arranged in the transformer region 202, and the region on the winding substrate 10 corresponding to the transformer region 202 further comprises three magnetic core hole grooves 105 for the three magnetic columns of the transformer magnetic core 50 to penetrate through, so that the transformer magnetic core 50 is buckled with the winding substrate 10 from the first surface 101 and the second surface 102 respectively. The inductor magnetic core 60 is arranged in the inductor region 203, the region on the winding substrate 10 corresponding to the inductor region 203 further comprises three magnetic core hole grooves 106, and the three magnetic columns of the power supply magnetic core 60 penetrate through the three magnetic core hole grooves 106 respectively, so that the inductor magnetic core 60 is buckled with the winding substrate 10 from the first surface 101 and the second surface 102 respectively. The output positive pin Vo+ and the output negative pin Vo− and at least one output capacitor Co are arranged in the output pin region 204. The power circuit region 201, the transformer region 202, the inductor region 203 and the output pin region 204 are sequentially arranged in the X-axis direction (i.e., the long axis direction of the power conversion device), so that the path of the power current flowing from the input terminal of the power supply module to the output terminal of the power supply module is the shortest, and the advantages of minimum parasitic resistance and minimum conduction loss of the power current path are obtained. Referring to FIG. 3E, the circuit unit 1a and the circuit unit 1b are sequentially arranged along the Y-axis direction (i.e., the short axis direction of the power conversion device) in the power conversion device. The three magnetic core hole grooves 105 are sequentially arranged in the short axis direction, and the three magnetic core hole grooves 106 are sequentially arranged in the short axis direction. Similarly, the second surface 102 of the winding substrate 10 also comprises a power circuit region 201, a transformer region 202, an inductor region 203 and an output pin region 204. The power circuit region 201, the transformer region 202, the inductor region 203 and the output pin region 204 are arranged in sequence in the long axis direction, and correspondingly arranged with the power circuit region 201, the transformer region 202, the inductor region 203 and the output pin region 204 on the first surface 101. The switches and capacitor and the like of each circuit unit are arranged in the power circuit region 201. The transformer magnetic core 50 is arranged in the transformer region 202, the inductor magnetic core 60 is arranged in the inductor region 203, the output positive pin Vo+, the output negative pin Vo− and at least one output capacitor Co are arranged in the output pin region 204.

Specifically, the six switches, the two flying capacitors and the at least one input capacitor included in each circuit unit are arranged on the power circuit region 201 on the first surface 101 (as shown in 3F), the power circuit region 201 comprises an upper switch region 211, a middle switch region 212, a lower switch region 213 and flying capacitor regions 221/222. Only the circuit unit 1a is used as an example, the upper switches Q1 and Q3 are arranged in the upper switch region 211, the middle switches Q2 and Q4 are arranged in the middle switch region 212, the lower switches SR1 and SR2 are arranged in the lower switch region 213, the flying capacitor C1 is arranged in the flying capacitor region 221, and the flying capacitor C2 is arranged in the flying capacitor region 222. Furthermore, the upper switch region 211, the middle switch region 212 and the lower switch region 213 are sequentially arranged in the long axis direction, and the middle switch region 212 and the flying capacitor regions 221/222 are arranged between the upper switch region 211 and the lower switch region 213. In the embodiment, the flying capacitor region 221, the middle switch region 212 and the flying capacitor region 222 are sequentially arranged in the short axis direction, that is, the two flying capacitor regions are respectively arranged on two opposite sides of the middle switch region 212, but are not limited thereto. The upper switch Q1 and the lower switch SR1 in the same three-switch bridge arm are respectively arranged on two opposite sides of the middle switch region 212, and the upper switch Q3 and the lower switch SR2 in the same three-switch bridge arm are respectively arranged on two opposite sides of the middle switch region 212. In other words, on the first surface 101, a first connecting line passes through the projections of the upper switch Q1 and the lower switch SR1 on the first surface 101, a second connecting line passes through the projections of the upper switch Q3 and the lower switch SR2 on the first surface 101, and the first connecting line intersects with the second connecting line. Furthermore, the intersection point is located in the middle switch region 212. The flying capacitor C1 is adjacent to the upper switch of one three-switch bridge arm and the lower switch of the other three-switch bridge arm, and the flying capacitor C2 is adjacent to the lower switch of one three-switch bridge arm and the upper switch of the other three-switch bridge arm. At least one input capacitor Cin is disposed adjacent to the upper switch. According to the layout, the alternating current loop flowing through the flying capacitors C1 or C2 is minimum, the parasitic inductance of the alternating current loop is minimum, and therefore the switching loss of the power conversion device is reduced. The six switches, the two flying capacitors and the at least one input capacitor included in the circuit unit 1b are also arranged on the first surface 101 according to the layout of the circuit unit 1a, and details are not described again.

Specifically, the two middle switches, the two lower switches, the two flying capacitors and the at least one input capacitor included in each circuit unit are arranged in the power circuit region 201 on the second surface 102 (as shown in FIG. 3G), the power circuit region 201 comprises a middle switch region 212, a lower switch region 213 and a flying capacitor region 221 and 222. Here, only the circuit unit 1a is used as an example, the middle switch Q2 and Q4 are arranged in the middle switch region 212, the lower switch SR1 and SR2 are arranged in the lower switch region 213, the flying capacitor C1 is arranged in the flying capacitor region 221, and the flying capacitor C2 is arranged in the flying capacitor region 222. Furthermore, the middle switch region 212 and the lower switch region 213 are sequentially arranged in the long axis direction, and the middle switch region 212 and the flying capacitor regions 221 and 222 are arranged on the same side of the lower switch region 213. In the embodiment, the flying capacitor region 221, the middle switch region 212 and the flying capacitor region 222 are sequentially arranged in the short axis direction, that is, the two flying capacitor regions are arranged on the two opposite sides of the middle switch region 212 respectively, but not limited thereto. At least one input capacitor Cin is arranged adjacent to the middle switch. According to the layout mentioned above, the loop of the alternating current flowing through the flying capacitors C1 or C2 is minimum, the parasitic inductance of the alternating current loop is minimum, and therefore the switching loss of the power conversion device is reduced. The four switches, the two flying capacitors and the at least one input capacitor comprised in the circuit unit 1b are also arranged on the second surface 102 according to the layout of the circuit unit 1a, and details are not described again.

As shown in FIG. 3F and FIG. 3G, the switch provided on the first surface 102 corresponds to the switch provided on the first surface 101 in a one-to-one manner. The lower switch SR1 is taken as an example. The projections of the lower switch SR1 provided on the first surface 101 and the second surface 102 on the first surface 101 are at least partly overlap. such that the source or drain of the two lower switches SR1 provided on the first surface 101 and the second surface 102 realize the parallel electrical connection through holes or other via holes of the pin pads, making the shortest distance between the devices which are electrically connected, and the loss on the connecting paths between the devices is reduced; specially, the through holes or via holes can vertically penetrate through the winding substrate 10. The two lower switches SR2 arranged on the first surface 101 and the second surface 102 are similarly arranged, and the two middle switches Q2 and the two middle switches Q4 also adopt the same layout principle and are not repeated again. The positive voltage end of at least one input capacitor Cin located on the first surface 101 and the corresponding positive voltage end of at least one input capacitor Cin on the second surface 102 are short-circuited through the through hole or other via holes of the pin pads; specially, the through holes or via holes can vertically penetrate through the winding substrate 10. The negative voltage ends of at least one input capacitor Cin located on the first surface 101 and on the second surface 102 are also short-circuited through the through hole or other via holes of the pin pads. Similarly, in conjunction with FIG. 3A and FIG. 3B, the positive voltage ends of at least one output capacitor Co located in the output pin region 204 of the first surface 101 and in the output pin region 204 of the second surface 102 are short-circuited through the through holes or other via holes of the pin pads, the through holes or via holes vertically penetrate through the winding substrate 10. The negative voltage ends of at least one output capacitor Co located in the output pin region 204 of the first surface 101 and in the output pin region 204 on the second surface 102 are short-circuited through the through hole or other via holes of the pin pads, the through holes or via holes vertically penetrate through the winding substrate 10, and so that the positive voltage ends or the negative voltage ends of the capacitor arranged on the first surface 101 and the second surface 102 are electrically connected in parallel through the through hole or other via holes of the pin pads and the through holes or via holes vertically penetrate through the winding substrate 10, so that the shortest distance electric connection between the devices is realized, and the loss on the connecting paths between the devices is reduced.

As shown in FIG. 3E, a winding mode and an implementation mode of a circuit unit are shown on the basis of the top surface schematic diagram of the power conversion device Ain FIG. 3D. A part of the transformer winding TW3 is defined as a first surface-mounted winding TW31 which is from the lower node SWL3 to the winding short contact TP1 and is around the transformer side column 51b for one round. The first surface-mounted winding TW31 adopts a one-step forming electric conductor and is attached to the first surface 101 in SMT (Surface Mount Technology); and A part of the transformer winding TW4 is defined as a second surface-mounted winding TW41, which is from the lower node SWL4 to the winding short contact TP2 and is surround the transformer side column 51b for one round, The second surface-mounted winding TW41 adopts a one-step forming electric conductor and is also attached to the second surface 102 in SMT (Surface Mount Technology). A part of the transformer winding TW3 is defined as a first internal winding TW32, which is from the winding short contact TP1 to the winding connection point TL2; a part of the transformer winding TW4 is defined as a second internal winding TW42, which is from the winding short contact TP2 to the winding connection point TL2. The first internal winding TW32 and the second internal winding TW42 can be realized by the internal wiring layer of the winding substrate 10 and can also be realized with the embedded one-step forming of the electric conductor. In the present embodiment, the first internal winding TW32 and the second internal winding TW42 may be implemented using the internal wiring layer of the winding substrate 10, and the first internal winding TW32 and the second internal winding TW42 are arranged on the same layer, and the connection point of the first internal winding TW32 and the second internal winding TW42 may be directly connected to the first end of the inductive winding LW2 without the via hole. The first surface-mounted winding Tw31 and the second surface-mounted winding Tw41 are electrically connected with the first inner winding Tw32 or the second inner winding Tw42 through a via hole in the winding substrate. Referring to FIG. 3E, the first surface-mounted winding TW31 protrudes from the first surface 101, and the second surface-mounted winding TW41 protrudes from the second surface 102. The winding adopts a surface-mounted winding on the surface layer of the winding substrate and the internal winding in the winding substrate which are connected in series to form a complete winding of the transformer, so that the number of wiring layers in the winding substrate and the thickness of the winding substrate can be reduced. The internal winding in the winding substrate is realized with paralleled multiple wiring layers, the parasitic resistance of the transformer winding and the loss of the transformer winding is effectively reduced. The first internal winding TW32 and the second internal winding TW42 are arranged on the same layers, and the connection point of the first internal winding TW32 and the second internal winding TW42 can be directly connected to the first end of the LW2 without the via hole, so that the loss of the transformer and the connection points is further reduced. The winding connection point TL2 of the transformer winding TW3 and the transformer winding TW4 is short-circuited with one end of the output inductor LW2, the output inductor LW2 is wound twice on the side column 61b and then is electrically connected with the output positive terminal Vo+. The transformer winding channel and the inductor winding channel are opposite in position, and the transformer winding, the inductor winding and the output positive terminal are adjacently arranged, so that the conduction loss of path which the current flows through is effectively reduced. The implementation mode of the transformer winding of the circuit unit 1b also adopts the same mode, and details are not described again. In other embodiments, the surface-mounted winding can also be only arranged on the first surface or the second surface, and the number of winding turns arranged in the winding substrate is also not limited.

The method has the beneficial effects that the capacitance value of the input capacitor is reduced through two or more circuit units connected in parallel and a staggered phase control strategy. Meanwhile, the size of the magnetic assembly is reduced through a magnetic integration technology. Parasitic parameters are reduced through layout of the device, and the switching frequency of the power supply module is improved. The surface-mounted winding is arranged on the surface of the winding substrate, so that the parasitic resistance of the winding is reduced.

What is claimed is:

1. A magnetic assembly, comprising:
a magnetic core and two winding combinations;
wherein the magnetic core comprises a middle column, two side columns and two magnetic substrates, wherein the middle column and the two side columns are arranged between the two magnetic substrates, and the middle column is arranged between the two side columns;
wherein the two winding combinations are respectively wound on one side column, each winding combination comprises two windings which are connected with each other, the voltage at the two ends of one winding wound on one side column is 90 degrees out of phase with the voltage of the two ends of one winding wound on the other side column.

2. The magnetic assembly of claim 1, wherein a channel between the middle column and any side column is defined as a winding channel, each winding combination comprises two windings, one winding in the same winding combination passes through one winding channel in the first direction, and the other winding in the same winding combination passes through the same winding channel in the second direction.

3. The magnetic assembly of claim 1, wherein the phase shift between the alternating-current magnetic flux flowing through the two side columns along with time is 90 degrees, and the alternating-current magnetic flux flowing through the two side columns is superposed or subtracted on the middle column of the phase.

4. A magnetic assembly, comprising:
a magnetic core and at least two winding combinations;
wherein the magnetic core comprises a middle column, two side columns and two magnetic substrates, wherein the middle column and the two side columns are arranged between the two magnetic substrates, and the middle column is arranged between the two side columns;
wherein at least two winding combinations are respectively wound on one side column, each winding combination comprises two windings which are electrically connected, each winding comprises a first end and a second end, and the first end and the second end of each winding are located on the two opposite sides of the magnetic core respectively.

5. The magnetic assembly of claim 4, wherein a channel between the middle column and any side column is defined as a winding channel, each winding combination comprises two windings, one winding in the same winding combination passes through one winding channel in the first direction, and the other winding in the same winding combination passes through the same winding channel in the second direction.

6. The magnetic assembly of claim 4, wherein the phase shift between the alternating-current magnetic flux flowing through the two side columns along with time is 90 degrees, and the alternating-current magnetic flux flowing through the two side columns is superposed or subtracted on the middle column of the phase.

7. A magnetic assembly, comprising:
a magnetic core, a winding substrate, a first surface-mounted winding, a second surface-mounted winding and an internal winding;
wherein the magnetic core comprises at least one side column;
wherein the winding substrate comprises at least one magnetic core hole groove, at least two through holes, a first surface and a second surface which are opposite to each other, and at least one magnetic core hole groove penetrates through the first surface and the second surface for at least one side column to penetrate through;
wherein the first surface-mounted winding is arranged on the first surface, the second surface-mounted winding is arranged on the second surface, the internal winding is arranged in the winding substrate, and the first surface-mounted winding, the second surface-mounted winding and the internal winding are electrically connected through the via hole.

8. The magnetic assembly of claim 7, wherein the first surface-mounted winding is wound around the magnetic core hole groove for one round, and the second surface-mounted winding is wound around the magnetic core hole groove for one round.

9. The magnetic assembly of claim 8, wherein the inner winding is wound twice around the magnetic core hole groove.

10. The magnetic assembly of claim 9, wherein the internal winding comprises a first internal winding and a second internal winding, the first internal winding and the second internal winding are located on the same wiring layer, and connecting points of the first internal winding and the second internal winding and the via hole are arranged on two opposite sides of the magnetic core.

11. A power conversion circuit, comprising:
an input positive terminal, an input negative terminal, an output positive terminal and two switch bridge arms;
wherein each switch bridge arm comprises an upper switch, a middle switch and a lower switch, wherein the upper switch, the middle switch and the lower switch are sequentially and electrically connected in series, the connection points of the upper switch and the middle switch are upper nodes, and the connection points of the middle switch and the lower switch are lower nodes;
wherein an upper switch of each switch bridge arm is electrically connected to an input positive terminal, and a lower switch of each switch bridge arm is electrically connected to an input negative terminal;
wherein the power conversion circuit also comprises a switching frequency, the switching frequency varies linearly with the input voltage over an input voltage range, and the switching frequency is constant over another input voltage range.

12. The power conversion circuit of claim 11, wherein when the input voltage is smaller than a preset value, the switching frequency is reduced along with the reduction of the input voltage.

13. The power conversion circuit of claim 12, further comprising two flying capacitors, a transformer and an inductor, wherein each flying capacitor is respectively bridged between the upper node of one switch bridge arm and the lower node of the other switch bridge arm;
wherein the transformer comprises two transformer windings, the inductor comprises an inductor winding, the second ends of the two transformer windings are electrically connected and are electrically connected to the first end of the inductor winding, the first ends of the two transformer windings are electrically connected with two lower nodes respectively, and the second end of the inductor winding is electrically connected to the output negative terminal;
when the duty ratio D of the upper switch is smaller than or equal to 50%, the middle switch of one switch bridge arm and the upper switch of the other switch bridge arm are switched on and off at the same time;
when the duty ratio D of the upper switch is greater than 50%, the middle switch of one switch bridge arm and the lower switch of the other switch bridge arm are switched on and off at the same switch.

14. The power conversion circuit of claim 11, wherein when the input voltage is greater than a preset value, the switching frequency rises along with the increase of the input voltage.

15. The power conversion circuit of claim 14, further comprises a transformer and a resonant capacitor; the transformer comprises a high-voltage winding and two low-voltage windings; the high-voltage winding and the resonant capacitor are connected in series between the two upper nodes; the second ends of the two low-voltage windings are electrically connected to the output positive terminal, and the first ends of the two low-voltage windings are electrically connected with the two lower nodes respectively.

16. A power conversion circuit, comprising:
an input terminal, an output terminal, two circuit units and a clamping circuit;
wherein the two circuit units are electrically connected in parallel to the input terminal and the output terminal; each circuit unit comprises at least one switch and at least one capacitor;
wherein the clamping circuit comprises an absorption circuit and a discharge circuit, wherein the absorption circuit is bridged at two ends of at least one switch; one end of the discharge circuit is electrically connected with the absorption circuit, and the other end of the discharge circuit is electrically connected with the at least one capacitor in the other circuit unit.

17. The power conversion circuit of claim 16, wherein the absorption circuit comprises an absorption diode and an absorption capacitor, the discharge circuit comprises a discharge diode, one end of the discharge diode is electrically connected with the absorption capacitor and the absorption diode, and the other end of the discharge diode is electrically connected with at least one capacitor in the other circuit unit.

18. The power conversion circuit of claim 17, wherein each circuit unit comprises an upper switch, a middle switch, a lower switch and two switch capacitors, the upper switch, the middle switch and the lower switch are sequentially and electrically connected in series, the connection points of the upper switch and the middle switch are upper nodes, and the connection points of the middle switch and the lower switch are lower nodes; the input terminal comprises an input positive terminal and an input negative terminal, the upper switch of each switch bridge arm is electrically connected to the input positive terminal, and the lower switch of each switch bridge arm is electrically connected to the input negative terminal; and the two ends of each flying capacitor are separately connected the upper node of one switch bridge arm and the lower node of the other switch bridge arm.

19. The power conversion circuit of claim 18, wherein the absorption circuit is connected with the two ends of the upper switch in parallel, one end of the absorption capacitor is electrically connected with the input positive terminal, the other end of the absorption capacitor is electrically connected with the positive electrode of the absorption diode and the negative electrode of the discharge diode, the negative electrode of the absorption diode is electrically connected with one upper node, and the positive electrode of the discharge diode is electrically connected with any upper node of the other circuit unit.

20. The power conversion circuit of claim 18, wherein the absorption circuit is connected with the two ends of the lower switch in parallel, one end of the absorption capacitor is electrically connected with the input negative terminal, the other end of the absorption capacitor is electrically connected with the negative electrode of the absorption diode and the positive electrode of the discharge diode, the positive electrode of the absorption diode is electrically connected with the lower node, and the negative electrode of the discharge diode is electrically connected with the other upper node of the other circuit unit.

21. A power conversion device, comprising:
a winding substrate, a transformer, an inductor and at least one switch;
wherein the winding substrate comprises a first surface and a second surface which are opposite to each other;
wherein the first surface comprises a power circuit region, a transformer region and an inductor region;
wherein the power circuit region, the transformer region and the inductor region are sequentially arranged in the same direction;
wherein the at least one switch is arranged in the power circuit region, the transformer is arranged in the transformer region, and the inductor is arranged in the inductor region.

22. The power conversion device of claim 21, wherein the first surface further comprises an output pin region, and the inductor region is arranged between the output pin region and the transformer region.

23. The power conversion device of claim 21, wherein the at least one switch is a lower switch, and the lower switch is arranged in the power circuit region and adjacent to the transformer region.

24. The power conversion device of claim 23, wherein the transformer comprises a transformer magnetic core, the transformer magnetic core comprises two winding channels, a first winding channel side and a second winding channel side, and the two winding channels penetrate through the first winding channel side and the second winding channel side; and the lower switch is close to the first winding channel side, and the inductor region is close to the second winding channel side.

25. The power conversion device of claim 22, wherein the inductor comprises an inductor magnetic core, the inductor magnetic core comprises two winding channels, a first winding channel side and a second winding channel side, and the two winding channels penetrate through the first winding channel side and the second winding channel side; and the transformer region is close to the first winding channel side, and the output pin region is close to the second winding channel side.

26. A power conversion device, comprising:
a winding substrate, wherein the winding substrate comprises a first surface and a second surface which are opposite to each other, wherein the first surface comprises an upper switch region and a lower switch region; and
two switch bridge arms;
wherein each switch bridge arm comprises an upper switch, a middle switch and a lower switch, an upper switch and a middle switch in the same switch bridge arm are electrically connected to an upper node, and the middle switch and the lower switch are electrically connected to a lower node;
wherein each lower switch is arranged in the lower switch region, and each upper switch region is arranged in the upper switch region;
wherein the first surface further comprises a first connecting line and a second connecting line, the first connecting line passes through the projections of the upper switch and the lower switch in the same switch bridge arm on the first surface, the second connecting line passes through the projections of the upper switch and the lower switch in the other switch bridge arm on the first surface, and the first connecting line intersects with the second connecting line.

27. The power conversion device of claim 26, wherein the first surface further comprises a middle switch region, and the middle switch region is arranged between the upper switch region and the lower switch region; and a middle switch of each switch bridge arm is arranged in the middle switch region.

28. The power conversion device of claim 27, further comprises at least two flying capacitors, the first surface further comprises two flying capacitor regions; the two flying capacitor regions are arranged between the upper switch region and the lower switch region, and at least two flying capacitors are arranged in one flying capacitor region respectively; one end of each flying capacitor is electrically connected with the upper node of one switch bridge arm and the other end of each flying capacitor is electrically connected with the lower node of the other switch bridge arm.

29. The power conversion device of claim 28, wherein the two flying capacitor regions are respectively arranged on two opposite sides of the middle switch region.

30. The power conversion device of claim 29, wherein the power conversion device further comprises a transformer, the first surface further comprises a transformer region, the transformer is arranged in the transformer region, and the transformer region is arranged adjacent to the lower switch region.

31. A power conversion device, comprising:
a winding substrate, a transformer and an inductor, wherein the winding substrate comprises a first surface and a second surface which are opposite to each other; and the first surface comprises a transformer region and an inductor region;
wherein the transformer comprises a transformer magnetic core and a transformer winding, the transformer magnetic core comprises two transformer winding channels, a first transformer winding channel side and a second transformer winding channel side, the two transformer winding channels penetrate through the first transformer winding channel side and the second transformer winding channel side, and the transformer winding passes through the transformer winding channel;
wherein the inductor comprises an inductor magnetic core and an inductor winding, the inductor magnetic core comprises two inductor winding channels, a first inductor winding channel side and a second inductor winding channel side, the two inductor winding channels penetrate through the first inductor winding channel side and the second inductor winding channel side, and the inductor winding passes through the inductor winding channel; the second transformer winding side is close to the first transformer winding side;
wherein the transformer winding and the inductor winding are electrically connected to the winding connection point, and the winding connection point is located between the second transformer winding channel side and the first inductor winding channel side.

32. The power conversion device of claim 31, wherein the transformer winding comprises a first surface-mounted winding, a second surface-mounted winding and an internal winding, the first surface-mounted winding is arranged on the first surface, the second surface-mounted winding is arranged on the second surface, and the internal winding is arranged in the winding substrate.

33. The power conversion device of claim 32, wherein the winding substrate comprises at least one magnetic core hole groove and at least two through holes, the magnetic core hole groove penetrates through the first surface and the second surface, and the two through holes are used for being electrically connected with the first surface-mounted winding, the inner winding and the second surface-mounted winding.

34. The power conversion device of claim 32, wherein the first surface-mounted winding protrudes from the first surface, and the second surface-mounted winding protrudes from the second surface.
